(19) United States
(12) Patent Application Publication
(10) Pub. No.: US 2006/0104768 A1
(43) Pub. Date: May 18, 2006

(54) Spare tire removal and storage apparatus

(76) Inventors: Jeremy L. Park, Hailey, ID (US); Amy Park, Hailey, ID (US)

Correspondence Address: Raymond M. Galasso;Galasso & Associates LP, P.O. Box 26503, Austin, TX, 78755-0503, US

(21) Appl. No.: 11/235,011

(22) Filed: Sep. 26, 2005

Related U.S. Application Data
(60) Provisional application No. 60/613,253, filed on Sep. 27, 2004.

(51) Int. Cl. B62D 43/00

(52) U.S. Cl. 414/463

(57) ABSTRACT

A spare tire removal/remounting device which includes a motorized winch, a cable and reel, and a spare tire lifting device. The device is attached to a vehicle proximate the under side of the vehicle and is configure to be contained in the wheel well of the spare tire when the spare tire has been raised and remounted under the vehicle. The winch includes a motor and a quick disconnect wired remote control box. The remote control box controls the activation and deactivation of the motor. The motor receives power from the vehicles electrical system, and when activated operates the cable and reel. The reel extends and retracts the cable that contains a hook on one end. The hook attaches to a lifting plate via an eyebolt. The lifting plate is configured to receive the spare tire.

### PRIORITY UNDER 35 U.S.C. §119(e) & 37 C.F.R. §1.78

This nonprovisional application claims priority based upon the following prior U.S. provisional patent application entitled: Park Auto Spare, Application No. 60/613,253, filed Sep. 27, 2004, in the names of Jeremy L. Park and Amy Park, which is hereby incorporated by reference for all purposes.

### FIELD OF THE INVENTION

The present invention relates to a device for removing and storing a spare tire from a motor vehicle, and more specifically but not by way of limitation, a motorized device for facilitating the storage and removal of a spare tire from under a motor vehicle.

### BACKGROUND

Many existing vehicles, such as SUVs, mini-vans and pickup trucks are designed to utilize a spare tire storage located under the vehicle. There are many problems associated with the removal and mounting of a spare tire to a spare tire mount located in such a fashion. Often, this requires a user to bend over and crawl on the ground to remove the spare tire. Additionally, this setup makes the remounting of the spare tire also very difficult.

Accordingly there is a need for a device that can facilitate the easy removal and remounting of a spare tire stored under the carriage of the vehicle.

### SUMMARY OF THE INVENTION

The present invention is a spare tire removal/remounting device which includes a motorized winch, a cable and reel, and a spare tire lifting device. It is attached to a vehicle proximate the under side of the vehicle and is configure to be contained in the wheel well of the spare tire when the spare tire has been raised and remounted under the vehicle. The winch includes a motor and a quick disconnect wired remote control box. The remote control box controls the activation and deactivation of the motor. The motor receives power from the vehicles electrical system, and when activated operates the cable and reel. The reel extends and retracts the cable that contains a hook on one end. The hook attaches to a lifting plate via an eyebolt. The lifting plate is configured to receive the spare tire.

### BRIEF DESCRIPTION OF THE DRAWINGS

A more complete understanding of the present invention may be had by reference to the following Detailed Description and appended claims when taken in conjunction with the accompanying Drawings wherein:

FIG. 1 illustrates a side view of an embodiment of the present invention incorporated into a vehicle; and

FIG. 2 illustrates a partially exploded perspective view of an embodiment of the present invention.

### DETAILED DESCRIPTION

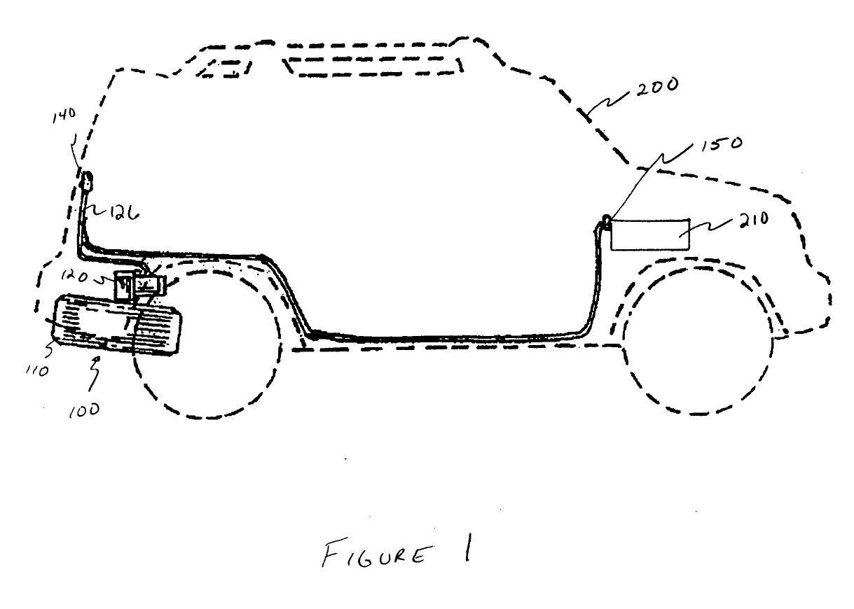

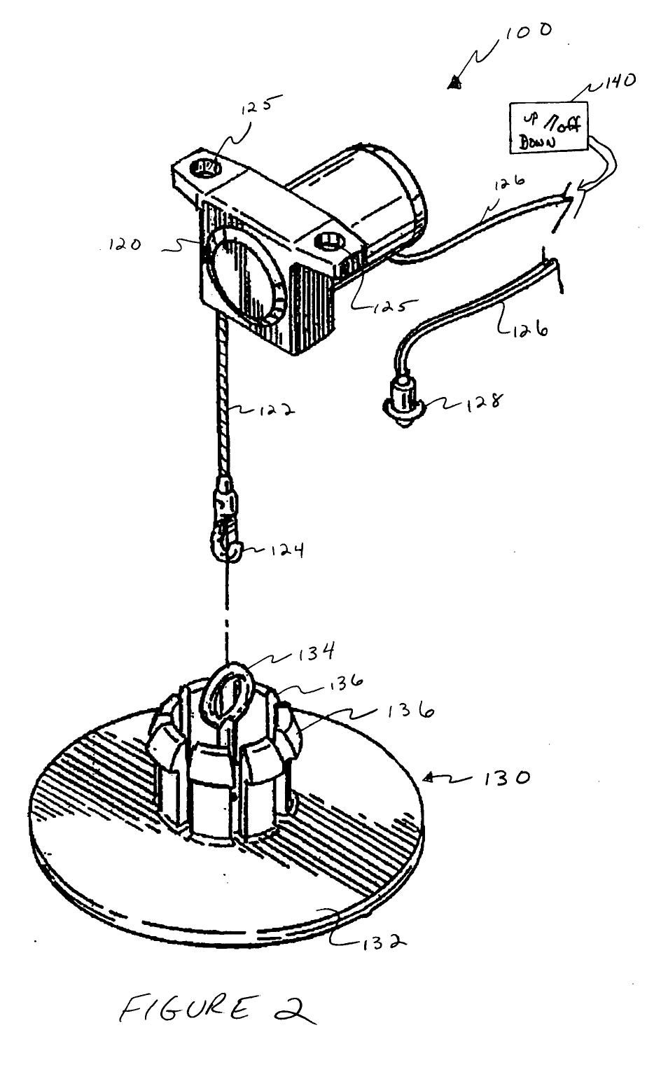

Referring now to the drawings, wherein various elements depicted are not necessarily drawn to scale, and in particular FIGS. 1 and 2 there is illustrated a spare tire mount 100 constructed according to the principles of the present invention.

As illustrated in FIG. 1, spare tire mount 100 includes a motorized electric winch 120 which is mounted under vehicle 200. Wiring 126 electrically connects winch 120 to a remote control 140 located proximate the rear of vehicle 200. Wiring 126 further connects winch 120 to power connection 150 which is connected to the electrical system 210 of vehicle 200. Power connection 150 enables power to be supplied through wiring 126 from the electrical system 210 of vehicle 200 for the operation of spare tire mount 100.

Remote control 140 includes an on/off switch (see FIG. 2) for facilitating the activation/deactivation of winch 120. Additionally, remote control 140 is configured to be easily disconnected from spare tire mount 100 to facilitate storage of remote control 140, which inhibits the theft of spare tire 110.

Still referring to FIG. 1, spare tire mount 100 is illustrated with spare tire 110 mounted to spare tire mount 100 and positioned in the stored position under vehicle 200.

Referring now to FIG. 2, there is illustrated a more detailed partially exploded view of spare tire mount 100. As illustrated in FIG. 2, spare tire mount 100 includes an electrically power motorized winch 120. As can be appreciated by one skilled in the art, winch 120 includes an internal reel which is rotatable during the operation of winch 120. Cable 122 is connected to the winch 120 such that cable 122 can be retracted or extended during the operation of winch 120. A hook 124 is connected to the end of cable 122. Mounts 125 facilitate the installation and securing of winch 120 to vehicle 200.

Spare tire holder 130 includes a tire plate 132, a hanging bolt 134 and connection tabs 136. Tire plate 132 is configured in size and shape to receiving a horizontally placed spare tire 110. Tabs 136 extend up from tire plate 132 and are configured to extend into and engage the rim of spare tire 110 to facilitate the connection of spare tire holder 130 to the spare tire 110. Hanging bolt 134 is connected to tire plate 132 and is configured to engage hook 124, such that once engaged, facilitates the raising and lowering of spare tire holder 130 by winch 120.

Still referring to FIG. 2, spare tire mount 100 can also be configured with a light 128, mounted proximate winch 120. Light 128 is connected by wiring 126 to remote control 140, such that when winch 120 is activated by remote control 140, light 128 will be also be activated, and provide light under that vehicle 200.

Referring now to FIGS. 1 and 2, a description of the operation of spare tire mount 100 is as follows. As can be appreciated, during the operation as described herein, if remote control 140 has been disconnected, remote control 140 must first be connected for the operation of winch 120. To mount spare tire 110 to spare tire mount 100, spare tire holder 130, cable 122 and hook 124 are extend by activating winch 120 in the down mode via switch 140. Once extended a sufficient amount, winch 120 is turned off by remote control 140. Spare tire holder 130 is disconnected from hook 124 and placed on a generally flat surface. Spare tire 110 is placed on its side and over hanging bolt 134, such that tabs 136 engage spare tire 110 and further such that spare tire 110 engages tire plate 132. Hanging bolt 134 of spare tire holder 130 is then connected and secured to hook 124.

Once hook 124 is secured to hanging bolt 134, winch 120 is activated by remote control 140 in the up mode. This retracts cable 122, bringing spare tire mount 100 and spare tire 110 up to the storage position under the vehicle as illustrated in FIG. 1.

Remote control 140 is mounted such it allows a user to operate spare tire mount 100 with a single hand, freeing one hand to guide the spare tire 110 into and out of storage position.

To remove spare tire 110 from spare tire mount 100, spare tire holder 130, cable 122 and hook 124 are extend by activating winch 120 in the down mode via switch 140. Once extended a sufficient amount, winch 120 is turned off by remote control 140. Spare tire holder 130 is placed on a generally flat surface. Hook 124 is then removed from hanging bolt 134. Spare tire 110 is then removed from tire plate 132.

As can be appreciated, winch 120 can be configure with automatic stops, such that cable 122 can be neither extended too far, or retracted too much.

In the preceding detailed description, reference has been made to the accompanying drawings that form a part hereof, and in which are shown by way of illustration specific embodiments in which the invention may be practiced. These embodiments, and certain variants thereof, have been described in sufficient detail to enable those skilled in the art to practice the invention. It is to be understood that other suitable embodiments may be utilized and that logical changes may be made without departing from the spirit or scope of the invention. The description may omit certain information known to those skilled in the art. The preceding detailed description is, therefore, not intended to be limited to the specific forms set forth herein, but on the contrary, it is intended to cover such alternatives, modifications, and equivalents, as can be reasonably included within the spirit and scope of the appended claims.

What is claimed is:

1. A device for facilitating the storage and removal of a spare tire from a vehicle, comprising:
a motor mounted to the vehicle;
a cable having a first end and a second end, said cable connected to said motor, said motor operable to raise and lower said cable; and
a tire holder, said tire holder configured to removably secure the spare tire thereon, said tire holder connected to said second end of said cable.

2. The device as recited in claim 1, and further including a light positioned proximate said motor.

3. The device as recited in claim 1, and further including a remote control, said remote control for at least controlling the operation of said motor.

4. The device as recited in claim 3, wherein said remote control is removable.

5. The device as recited in claim 1, wherein said tire holder includes a plate configured to receive thereon the spare tire.

6. The device as recited in claim 5, and further comprising at least one tab extending from said plate, said tab configured to engage the spare tire when said spare tire.

7. The device as recited in claim 6, and further comprising a hook connected to said second end of said cable.

8. The device as recited in claim 8, and further comprising a connector, said connector connected to said plate, said connector configured to connect with said hook.

9. A device for facilitating the storage and removal of a spare tire from a vehicle, comprising:
an electric motor mounted to the vehicle;
a cable having a first end and a second end, said cable connected to said motor, said motor operable to raise and lower said cable; and
a tire holder, said tire holder configured to removably secure the spare tire thereon, said tire holder connected to said second end of said cable.

10. The device as recited in claim 9, and further including a light positioned proximate said electric motor.

11. The device as recited in claim 10, and further including a remote control, said remote control for at least controlling the operation of said motor.

12. The device as recited in claim 11, wherein said remote control is removable.

13. The device as recited in claim 12, wherein said tire holder includes a plate configured to receive thereon the spare tire.

14. The device as recited in claim 13, and further comprising at least one tab extending from said plate, said tab configured to engage the spare tire when said spare tire.

15. The device as recited in claim 14, and further comprising a hook connected to said second end of said cable.

16. The device as recited in claim 15, and further comprising a connector, said connector connected to said plate, said connector configured to connect with said hook.

17. A device for facilitating the storage and removal of a spare tire from a vehicle, comprising:
a winch configured to be mounted under the vehicle, said winch including an electric motor;
a cable having a first end and a second end, said cable connected to said winch, said winch operable to raise and lower said cable; and
a tire holder, said tire holder configured to removably secure the spare tire thereon, said tire holder connected to said second end of said cable.

18. The device as recited in claim 17, and further including a remote control, said remote control for at least controlling the operation of said winch, said remote control being removable.

19. The device as recited in claim 18, wherein said tire holder includes a plate configured to receive thereon the spare tire, said plate including a plurality of tabs extending from said plate, said plurality of tabs configured to engage the spare tire when said spare tire.

20. The device as recited in claim 19, and further comprising a hook connected to said second end of said cable, and further comprising a connector said, said connector connected to said plate, said connector configured to connect with said hook.
